(19) United States
(12) Patent Application Publication
(10) Pub. No.: US 2025/0074768 A1
(43) Pub. Date: Mar. 6, 2025

(54) METHOD FOR PRODUCING HYDROGEN FROM NATURAL GAS

(71) Applicant: KING FAHD UNIVERSITY OF PETROLEUM AND MINERALS, Dhahran (SA)

(72) Inventors: Mohammad Mozahar HOSSAIN, Dhahran (SA); Wasim Ullah KHAN, Dhahran (SA)

(73) Assignee: KING FAHD UNIVERSITY OF PETROLEUM AND MINERALS, Dhahran (SA)

(21) Appl. No.: 18/459,577

(22) Filed: Sep. 1, 2023

(51) Int. Cl. C01B 3/26; B01J 21/06; B01J 23/755; B01J 35/10; B01J 37/00; B01J 37/02; B01J 37/03; B01J 37/04; B01J 37/08; B01J 37/18; C01B 32/162

(52) U.S. Cl. CPC C01B 3/26; B01J 21/063; B01J 23/755; B01J 35/613; B01J 35/615; B01J 35/633; B01J 35/635; B01J 35/647; B01J 37/009; B01J 37/0236; B01J 37/035; B01J 37/04; B01J 37/088; B01J 37/18; C01B 32/162; C01B 2202/06; C01B 2202/34; C01B 2202/36; C01B 2203/0277; C01B 2203/0805; C01B 2203/1058; C01B 2203/1082; C01B 2203/1241; C01P 2004/133

(57) ABSTRACT

A method for producing hydrogen (H₂) from methane (CH₄) includes introducing a feed gas stream containing CH₄ into a reactor containing a nickel (Ni) and cobalt (Co)-based titania supported (NCT) catalyst; passing the feed gas stream through the reactor in contact with the NCT catalyst at a temperature of 600 to 1000° C. to convert CH₄ to carbon (C) and H₂, and produce an H₂-containing gas stream leaving the reactor; and separating H₂ from the H₂-containing gas stream. The method has a CH₄ conversion of up to 95% of the initial weight of CH₄ and a H₂ yield of up to 90% based on the CH₄ conversion.

### STATEMENT REGARDING PRIOR DISCLOSURE BY THE INVENTORS

Aspects of this technology are described in “Synthesis of COₓ-free hydrogen via natural gas decomposition over titanium dioxide-supported bimetallic catalysts” published in International Journal of Hydrogen Energy, May 2023, which is incorporated herein by reference in its entirety.

### STATEMENT OF ACKNOWLEDGEMENT

This research was supported by the Deanship of Research Oversight and Coordination (DROC) at King Fahd University of Petroleum and Minerals under the project KU201002.

### BACKGROUND

### Technical Field

The present disclosure is directed to a method for producing hydrogen, and particularly to a method for producing hydrogen from natural gas using a nickel and cobalt-based titania supported catalyst.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Non-renewable fossil fuels currently serve as major energy sources; however, their combustion leads to severe global environmental consequences. In contrast, hydrogen is a promising alternative energy source because it produces only water upon combustion, rendering it a potentially sustainable fuel choice. As a result, pure hydrogen synthesis has become a focus of research in recent years. Natural gas (methane) cracking provides a one-step process of hydrogen production along with valuable carbon, without emitting environmentally harmful gases. The endothermic nature of this reaction and the symmetry of methane molecules require high temperatures (e.g., greater than 1200° C.) for non-catalytic and/or direct methane cracking. However, incorporating catalysts can reduce the required reaction temperature to a practical range, making the process more efficient.

Homogeneous and heterogeneous catalysts based on metal as well as activated carbon have been studied to address the high-temperature challenges in methane cracking for hydrogen production, as well as the generation of valuable carbon nanomaterials. Both noble and non-noble metals have been utilized as catalysts, and among the transition metals, nickel (Ni), cobalt (Co), and iron (Fe) have been investigated at different ranges of reaction temperatures. Ni has a distinct three-dimensional orbital structure that facilitates its utilization with higher activity at a lower range of reaction temperature, typically around 500-700° C. In comparison to Ni, Co-based catalysts are more expensive and toxic, which limits their application in catalytic methane cracking (CMC). However, Co-based catalysts exhibit attractive features such as the absence of an induction period, a characteristic not shared with Ni, as well as the capability to yield superior high-quality carbon nanotubes. The use of oxide supports helps disperse active metal particles efficiently and addresses the problem of particle agglomeration and sintering at operating temperatures. Various support materials such as alumina, silica, ceria, zirconia, magnesia, and lanthana are used to tune active metal surface area and enhance the efficiency of the CMC reaction.

Numerous studies have explored and discussed aspects of CMC. The formation of carbon nanomaterials as a byproduct of CMC may be influenced by the nature of the active metal, type of supports, and various operating parameters. Metal-support interaction (MSI) also plays a role in tuning the typical CMC reaction pathway. Titanium dioxide (TiO₂), also known as Titania, may be used in the optical sector due to its semiconducting nature and superior textural properties, such as photocatalytic dye degradation and hydrogen production from water splitting. However, compared to supports like alumina and silica, titania is underexplored as a supporting material for CMC reactions. There is a pressing need for further research to uncover its capacity to enhance the efficiency of CMC processes.

U.S. Ser. No. 11/040,876B2 describes catalysts and processes for tunable base-grown multi-walled carbon nanotubes. U.S. Ser. No. 10/010,874B2 describes catalytic decomposition of lower hydrocarbons to produce carbon oxides free hydrogen and bamboo-shaped carbon nanotubes. U.S. Pat. No. 9,061,909B2 describes method for simultaneously producing carbon nanotubes and hydrogen, and device for simultaneously producing carbon nanotubes and hydrogen. However, none of the prior art references discloses a method for producing hydrogen from natural gas in an efficient manner using a nickel and cobalt-based titania supported catalyst.

In view of the foregoing, it is one objective of the present disclosure to provide methods and systems for producing hydrogen from natural gas. A second objective of the present disclosure is to provide a method of making a nickel and cobalt-based titania supported catalyst.

### SUMMARY

In an exemplary embodiment, a method for producing hydrogen (H₂) from methane (CH₄) is described. The method includes introducing a feed gas stream containing CH₄ into a reactor containing a nickel (Ni) and cobalt (Co)-based Titania supported (NCT) catalyst containing NCT catalyst particles. In some embodiments, the Ni is present in the NCT catalyst at a concentration of 20 to 30 wt. % based on a total weight of the NCT catalyst. In some embodiments, the Co is present in the NCT catalyst at a concentration of 10 to 30 wt. % based on the total weight of the NCT catalyst. The method further includes passing the feed gas stream through the reactor in contact with the NCT catalyst particles at a temperature of 600 to 1000° C. to convert at least a portion of the CH₄ to carbon (C) and H₂, and produce a H₂-containing gas stream leaving the reactor. In some embodiments, the C formed during the CH₄ conversion is deposited on surfaces of the NCT catalyst particles. Additionally, the method includes separating the H₂ from the H₂-containing gas stream. In some embodiments, the method has a CH₄ conversion of up to 95% based on an initial weight of the CH₄ in the feed gas stream. In some embodiments, the method has a H₂ yield of up to 90% based on the CH₄ conversion.

In some embodiments, the CH₄ is present in the feed gas stream at a concentration of 50 to 95 vol. % based on a total volume of the feed gas stream.

In some embodiments, the feed gas stream further includes ethane, propane, butane, nitrogen, and argon.

In some embodiments, the reactor is at least one selected from the group consisting of a fixed-bed reactor, a trickle-bed reactor, a moving bed reactor, a rotating bed reactor, a fluidized bed reactor, and a slurry reactor.

In some embodiments, the reactor is a fixed-bed reactor in the form of a cylindrical reactor including a top portion, a cylindrical body portion, a bottom portion, a housing having an open top and open bottom supportably maintained with the cylindrical body portion. In some embodiments, the NCT catalyst particles are supportably retained within the housing permitting fluid flow therethrough. In some embodiments, the fixed-bed reactor also includes at least one propeller agitator that is disposed in the bottom portion of the reactor. In some embodiments, the bottom portion is cone shaped or pyramidal. In some embodiments, a plurality of recirculation tubes fluidly connects the bottom portion of the cylindrical reactor with the cylindrical body portion of the cylindrical reactor.

In some embodiments, during the passing, the feed gas stream is in contact with the NCT catalyst particles at a temperature of 700 to 800° C. under atmospheric pressure.

In some embodiments, the passing is performed at a gas hourly space velocity (GHSV) of 2 to 10 liters of the feed gas stream of every gram of the NCT catalyst per hour (L/(h·g_{cat})).

In some embodiments, the carbon deposited on surfaces of the NCT catalyst is in the form of multi-walled carbon nanotubes (MWCNTs).

In some embodiments, the MWCNTs have an average diameter of 10 to 60 nanometers (nm) and a length in a range of 100 nm to 9 millimeters (mm).

In some embodiments, the MWCNTs are hollow multi-walled carbon nanotubes having open tips, and wherein Ni and Co particles reside within the inner surfaces of the hollow multi-walled carbon nanotubes.

In some embodiments, the H₂-containing gas stream leaving the reactor is free from carbon oxides (COₓ).

In some embodiments, the NCT catalyst particles have a specific surface area in a range of 30 to 140 square meter per gram (m²/g).

In some embodiments, the NCT catalyst particles have a cumulative specific pore volume in a range of 0.1 to 0.5 cubic centimeter per gram (cm³/g).

In some embodiments, the NCT catalyst particles have an average pore diameter in a range of 5 to 20 nm.

In some embodiments, the NCT catalyst particles have a hydrogen temperature-programmed reduction (H₂-TPR) of 1.5 to 10 millimoles per gram (mmol/g).

In some embodiments, the NCT catalyst is prepared by mixing a nickel salt and a cobalt salt in a first solvent to form a first mixture; adjusting a pH of the first mixture by adding an ammonia solution until the pH of the first mixture reaches about 9, and mixing with a titanium salt to form a reaction mixture; heating the reaction mixture to form a catalyst precursor in the reaction mixture; precipitating the catalyst precursor from the reaction mixture by cooling, filtering and drying to form the catalyst precursor in a solid form; and calcining the catalyst precursor at a temperature of 500 to 900° C. to form the NCT catalyst. In some embodiments, a molar ratio of the nickel salt and the cobalt salt is in a range of 10:1 to 1:10. In some embodiments, the Ni is present in the NCT catalyst at a concentration of 10 to 30 wt. % based on a total weight of the NCT catalyst. In some embodiments, the Co is present in the NCT catalyst at a concentration of 10 to 30 wt. % based on the total weight of the NCT catalyst.

In some embodiments, the cobalt salt includes cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or a hydrate thereof.

In some embodiments, the nickel salt includes nickel sulfate, nickel acetate, nickel chloride, nickel nitrate, nickel carbonate, nickel phosphate and nickel oxalate, and/or a hydrate thereof.

In some embodiments, the titanium salt is at least one titanium alkoxide selected from the group consisting of titanium tetra-n-propoxide, titanium iso-propoxide, titanium tetramethoxide, titanium tetraethoxide, and titanium tetra-n-butoxide.

In some embodiments, the heating the reaction mixture is performed at a temperature of 40 to 100° C.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A depicts a method for producing nickel and cobalt-based bimetallic catalysts supported on titania (NCT catalyst), according to certain embodiments;

FIG. 1B depicts a method for producing hydrogen (H₂) from methane (CH₄), according to certain embodiments;

FIG. 2 shows a plot illustrating X-ray diffraction (XRD) profiles for two catalysts of nickel (Ni) and cobalt (Co)-based Titania supported (xNCT) catalyst series including 20NCT and 25NCT catalysts, according to certain embodiments;

FIG. 3 shows a plot illustrating temperature programmed reduction (TPR) profiles for three catalysts of xNCT series including 20NCT, 25NCT, and 30NCT catalysts, according to certain embodiments;

FIG. 4 shows a plot illustrating catalytic performance curves in terms of CH₄ conversion for xNCT catalysts at temperature of 700° C., according to certain embodiments;

FIG. 5 shows a plot illustrating carbon yield data for xNCT catalysts, according to certain embodiments;

FIG. 6 shows a plot illustrating thermo-gravimetric analysis (TGA) curves for xNCT spent catalysts, according to certain embodiments;

FIG. 7A shows a scanning electron microscope (SEM) micrograph of the 25NCT spent catalyst, according to certain embodiments;

FIG. 7B shows a high resolution transition electron microscope (HRTEM) micrograph of the 25NCT spent catalyst, according to certain embodiments;

FIG. 8 shows a plot illustrating catalytic activity profiles for 25NCT catalyst, at different calcination temperatures, according to certain embodiments;

FIG. 9 shows a plot illustrating TPR profiles for 25NCT catalyst, at different calcination temperatures, according to certain embodiments, and

FIG. 10 shows a plot illustrating XRD profiles for 25NCT catalyst, at different calcination temperatures, according to certain embodiments.

### DETAILED DESCRIPTION

In the drawings, like reference numerals designate identical or corresponding parts throughout the several views. As used herein, the words “a” and “an” and the like carry the meaning of “one or more.” Within the description of this disclosure, where a numerical limit or range is stated, the endpoints are included unless stated otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

Aspects of the present disclosure are directed to a method for producing hydrogen (H₂) from a natural gas feed stream, i.e., preferably a methane (CH₄) stream. The method utilizes nickel and cobalt-based bimetallic catalysts supported on titania, referred to as xNCT catalysts, where x represents a weight percentage ranging from 1 to 45 wt. %, preferably 5 to 40 wt. %, or even more preferably 10 to 30 wt. % (with total metal loading within 20 to 60 wt. %) for the purpose of CH₄ cracking into H₂ and carbon nanotubes. The manner in which H₂ is produced from CH₄ is described hereinafter.

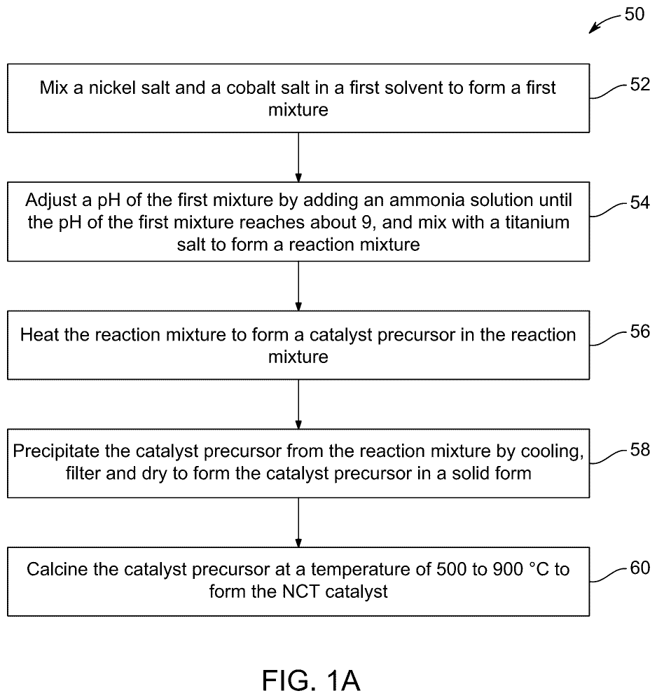

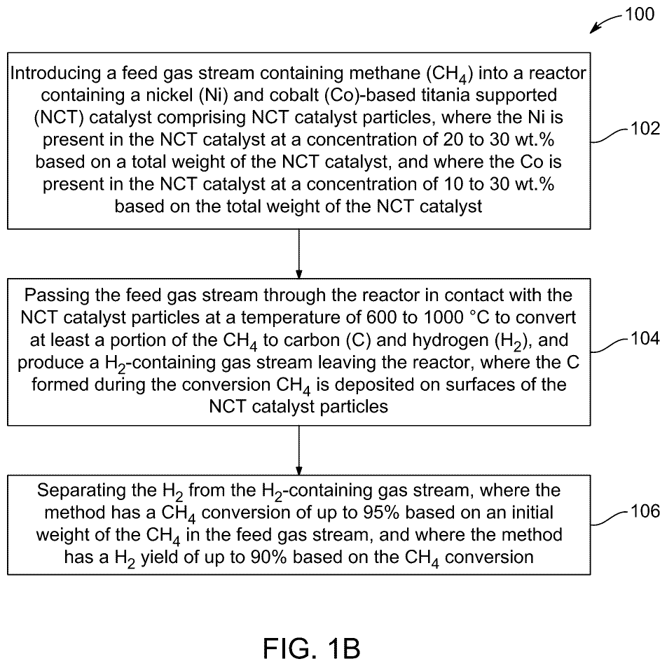

Referring to FIG. 1A, a method 50 of preparing the NCT catalyst is described. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 52, the method 50 includes mixing a nickel salt and a cobalt salt in a first solvent to form a first mixture. In some embodiments, the cobalt salt includes cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or a hydrate thereof. In a preferred embodiment, the cobalt salt is cobalt nitrate, and/or a hydrate thereof. In some embodiments, the nickel salt includes nickel sulfate, nickel acetate, nickel chloride, nickel nitrate, nickel carbonate, nickel phosphate and nickel oxalate, and/or a hydrate thereof. In a preferred embodiment, the nickel salt is nickel nitrate, and/or a hydrate thereof. In some embodiments, the molar ratio of the nickel salt and the cobalt salt is in a range of 10:1 to 1:10, preferably 8:1 to 1:8, preferably 6:1 to 6:1, preferably 4:1 to 1:4, or even more preferably 2:1 to 1:2. Other ranges are also possible.

At step 54, the method 50 includes adjusting a pH of the first mixture by adding an ammonia solution until the pH of the first mixture reaches about 8.5 to 10, preferably 9 to 9.5, and mixing with a titanium salt to form a reaction mixture. In some embodiments, the ammonia solution has a concentration of 28 wt. % in water. Optionally, other inorganic bases, as may be obvious to a person skilled in the art, may be added as well until the pH of the first mixture is about 9. The titanium salt is further added to the first mixture. The titanium salt is at least one titanium alkoxide selected from titanium tetra-n-propoxide, titanium iso-propoxide, titanium tetramethoxide, titanium tetraethoxide, and titanium tetra-n-butoxide. In a preferred embodiment, the titanium alkoxide is titanium isopropoxide.

At step 56, the method 50 includes heating the reaction mixture to form a catalyst precursor in the reaction mixture. In some embodiments, the heating of the reaction mixture is performed at a temperature of 40 to 100° C., preferably 50-90° C., preferably 60-80° C. for 2-5 hours, preferably 3-4 hours, preferably 3 hours, to form the catalyst precursor. Other ranges are also possible. It is preferred to have the reaction mixture intermittently/constantly using a stirrer/agitator/etc.

At step 58, the method 50 includes precipitating the catalyst precursor from the reaction mixture by cooling, filtering, and drying to form the catalyst precursor in a solid form. After the cooling and filtering, the catalyst precursor may be dried at a temperature in a range of 100-140° C., preferably 110-130° C., or even more preferably 120° C., to remove any organic solvents and moisture. Other ranges are also possible. The catalyst precursor, after drying, is in a solid form.

At step 60, the method 50 includes calcining the catalyst precursor at a temperature of 500 to 900° C. to form the NCT catalyst. The calcination may be carried out by placing the catalyst precursor into a furnace such as a tube furnace, for example, in a ceramic crucible (e.g., an alumina crucible) or other forms of containment, and heating to the temperatures described above. The furnace is preferably equipped with a temperature control system, which may provide a heating rate of up to 50° C./min, or preferably up to 40° C./min, or preferably up to 30° C./min, preferably up to 20° C./min, preferably up to 10° C./min, preferably up to 5° C./min. Other ranges are also possible. The calcination may be carried out for a period of 2-5 hours, preferably 3-4 hours, or even more preferably about 3 hours. Other ranges are also possible.

In some embodiments, the NCT catalyst includes nanoparticles of Ni and Co disposed on the titania support. In some embodiments, the NCT catalyst prepared by the method of the present disclosure has a Ni content at a concentration of 10 to 30 wt. %, preferably 15 to 25 wt. %, or even more preferably about 20 wt. %, based on the total weight of the NCT catalyst. Further, the Co is present in the NCT catalyst at a concentration of 10 to 30 wt. %, preferably 15 to 25 wt. %, or even more preferably about 20 wt. %, based on the total weight of the NCT catalyst. Other ranges are also possible. In some embodiments, the Ni and Co nanoparticles present in the NCT catalyst are homogeneously disposed on the titania support. In some further embodiments, the Ni and Co nanoparticles present in the NCT catalyst are non-homogeneously disposed on the titania support.

In some embodiments, the titania (also known as titanium dioxide “TiO₂”) support present in the NCT catalyst may be any polymorph or phase of titanium dioxide. In some embodiments, the titanium dioxide is amorphous titanium dioxide. In some embodiments, the titanium dioxide is crystalline titanium dioxide. The crystalline titanium dioxide may adopt any suitable crystal structure or be any suitable phase of titanium dioxide. Examples of such phases include (α-TiO₂), Anatase (β-TiO₂), and brookite. In some embodiments, the titanium dioxide of the present disclosure may have an average particle size of 100 to 1000 nm, preferably 200 to 800 nm, preferably 300 to 700 nm, preferably 400 to 600 nm, or even more preferably about 500 nm. In some other embodiments, the titanium dioxide of the present disclosure may have an average particle size of 1 to 20 micrometers (μm), preferably 2 to 15 μm, preferably 3 to 10 μm, or even more preferably 4 to 5 μm. Other ranges are also possible. In general, the titanium dioxide particles can be any shape known to one of ordinary skill in the art. Examples of suitable shapes the titanium dioxide particles may take include spheres, spheroids, needles, sheets, platelets, disks, rods, irregular shapes, and mixtures thereof.

In some embodiments, the Ni and Co nanoparticles present in the NCT catalyst are separate nanoparticles of Ni and nanoparticles of Co. In some embodiments, the Ni and Co nanoparticles present in the NCT catalyst are in the form of alloy nanoparticles. Such alloy nanoparticles may have a homogeneous distribution of Ni and Co atoms or a non-homogeneous distribution of Ni and Co atoms. For example, the alloy nanoparticles may be formed of a bimetallic alloy, have a mixed but non-uniform distribution of Ni and Co, be Janus particles having a Ni side and a Co side, or have stripes of Ni and stripes of Co.

In some embodiments, the alloy nanoparticles present in the NCT catalyst can be any shape known to one of ordinary skill in the art. Examples of suitable shapes the alloy nanoparticles may take include spheres, spheroids, lentoids, ovoids, solid polyhedra such as tetrahedra, cubes, octahedra, icosahedra, dodecahedra, hollow polyhedral (also known as nanocages), stellated polyhedral (both regular and irregular, also known as nanostars), triangular prisms (also known as nanotriangles), hollow spherical shells (also known as nanoshells), tubes (also known as nanotubes), nanosheets, nanoplatelets, nanodisks, rods (also known as nanorods), and mixtures thereof.

In some embodiments, the alloy nanoparticles have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of the alloy nanoparticles having a different shape. As used herein, the term “non-uniform shape” refers to an average consistent shape that differs by more than 10% of the distribution of the alloy nanoparticles having a different shape. In one embodiment, the shape is uniform and at least 90% of the alloy nanoparticles are spherical or substantially circular, and less than 10% are polygonal. In another embodiment, the shape is non-uniform and less than 90% of the alloy nanoparticles are spherical or substantially circular, and greater than 10% are polygonal.

In some embodiments, the alloy nanoparticles have a mean particle size of 1 to 100 nm, preferably 3 to 90 nm, preferably 5 to 80 nm, preferably 7 to 70 nm, preferably 8 to 60 nm, preferably 11 to 50 nm, preferably 13 to 40 nm, preferably 15 to 30 nm, or even more preferably about 17 to 20 nm. Other ranges are also possible. In embodiments where the alloy nanoparticles present in the NCT catalyst are spherical, the particle size may refer to a particle diameter. In embodiments where the alloy nanoparticles are polyhedral, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the alloy nanoparticles have an anisotropic shape such as nanorods, the particle size may refer to a length of the nanorod, a width of the nanorod, an average of the length and width of the nanorod. In some embodiments in which the nanoparticles have non-spherical shapes, the particle size refers to the diameter of a sphere having an equivalent volume as the particle. In some embodiments in which the alloy nanoparticles have non-spherical shapes, the particle size refers to the diameter of a sphere having an equivalent diffusion coefficient as the particle.

In some embodiments, the Ni and Co nanoparticles present in the NCT catalyst of the present disclosure in the form of alloy nanoparticles are monodisperse, having a coefficient of variation or relative standard deviation, expressed as a percentage and defined as the ratio of the particle size standard deviation (σ) to the particle size mean (μ) multiplied by 100 of less than 25%, preferably less than 10%, preferably less than 8%, preferably less than 6%, preferably less than 5%, preferably less than 4%, preferably less than 3%, preferably less than 2%. In some embodiments, the alloy nanoparticles of the present disclosure are monodisperse having a particle size distribution ranging from 80% of the average particle size to 120% of the average particle size, preferably 90-110%, preferably 95-105% of the average particle size. In some embodiments, the alloy nanoparticles are not monodisperse.

In general, the particle size may be determined by any suitable method known to one of ordinary skill in the art. In some embodiments, the particle size is determined by powder X-ray diffraction (PXRD). Using PXRD, the particle size may be determined using the Scherrer equation, which relates the full-width at half-maximum (FWHM) of diffraction peaks to the size of regions comprised of a single crystalline domain (known as crystallites) in the sample. In some embodiments, the crystallite size is the same as the particle size. For accurate particle size measurement by PXRD, the particles should be crystalline, comprise only a single crystal, and lack non-crystalline portions. Typically, the crystallite size underestimates particle size compared to other measures due to factors such as amorphous regions of particles, the inclusion of non-crystalline material on the surface of particles such as bulky surface ligands, and particles which may be composed of multiple crystalline domains. In some embodiments, the particle size is determined by dynamic light scattering (DLS). DLS is a technique which uses the time-dependent fluctuations in light scattered by particles in suspension or solution in a solvent, typically water to measure a size distribution of the particles. Due to the details of the DLS setup, the technique measures a hydrodynamic diameter of the particles, which is the diameter of a sphere with an equivalent diffusion coefficient as the particles. The hydrodynamic diameter may include factors not accounted for by other methods such as non-crystalline material on the surface of particles such as bulky surface ligands, amorphous regions of particles, and surface ligand-solvent interactions. Further, the hydrodynamic diameter may not accurately account for non-spherical particle shapes. DLS does have an advantage of being able to account for or more accurately model solution or suspension behavior of the particles compared to other techniques. In some embodiments, the particle size is determined by electron microscopy techniques such as scanning electron microscopy (SEM) or transmission electron microscopy (TEM).

The NCT catalyst, was characterized using H₂-temperature-programmed reduction (H₂-TPR). Temperature programmed desorption (TPD) is a technique used to monitor surface interactions between molecular species on a surface when the surface temperature has changed in a controlled setting. This technique determines the strength of interactions between the catalyst material and hydrogen gas on the catalyst material. This is done by placing the catalyst material inside a reactor and pushing an inert gas into the chamber. Alternatively, the sample can be located in an ultra-high vacuum (UHV) chamber with no carrier gas. The sample is dosed with a probe gas such as CO, NH₃, H₂, etc. The sample is then increased in temperature at a linear ramp rate, and the desorption products are analyzed by a mass spectrometer.

The H₂-TPP may be conducted on a Micromeritics Auto Chem II 2920 equipment. The NCT catalyst was heated at a temperature of 100 to 1000° C., preferably about 200 to 900° C. under a H₂/Ar gas flow for 30 to 90 min, preferably about 60 min at a flow rate of 10 to 70 milliliters per minute (mL/min), preferably 30 mL/min. Other ranges are also possible. In some preferred embodiments, H₂ is present in the H₂/Ar gas mixture at a concentration of 1 to 20%, preferably about 5 to 15%, or even more preferably about 10% by volume. In some more preferred embodiments, the Micromeritics Auto Chem II 2920 equipment containing the NCT catalyst is heated to a temperature of 600 to 700° C., preferably about 650° C. at a heating rate of 5 to 30° C./min, preferably 5 to 20° C./min, or even more preferably about 10° C./min. Other ranges are also possible.

In some embodiments, the NCT catalyst particles of the NCT catalyst have a specific surface area in a range of 30 to 140, preferably 40 to 130, preferably 45-120 square meters per gram (m²/g). Other ranges are also possible. In some embodiments, the NCT catalyst particles have a cumulative specific pore volume in a range of 0.1 to 0.5, preferably 0.1 to 0.4, preferably 0.1 to 0.3, or even more preferably about 0.2 cubic centimeters per gram (cm³/g). Other ranges are also possible. Also, the NCT catalyst particles have an average pore diameter in a range of 5 to 20 nm, preferably 10 to 20 nm, or even more preferably about 15 nm. Additionally, the NCT catalyst particles have a hydrogen temperature-programmed reduction (H₂-TPR) of 1.5 to 10, preferably 2 to 9, or even more preferably 3 to 8 millimoles per gram (mmol/g). Other ranges are also possible.

The crystalline structures of the NCT catalyst may be characterized by X-ray diffraction (XRD). The XRD patterns are collected in a Rigaku MiniFlex diffractometer equipped with a Cu-Kα radiation source (λ=0.15416 nm) for a 2θ range extending between 5 and 100°, preferably 15 and 80°, further preferably 30 and 60° at an angular rate of 0.005 to 0.04° s⁻¹, preferably 0.01 to 0.03° s⁻¹, or even preferably 0.02° s⁻¹.

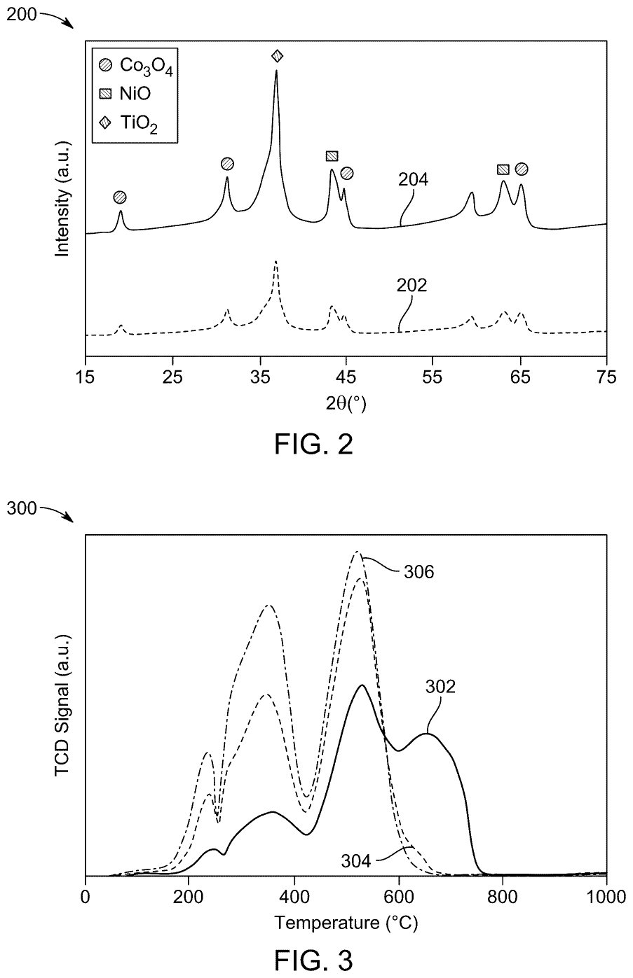

Referring to FIG. 2, XRD profiles for NCT catalysts with different metal loadings. In some embodiments, the NCT catalyst has at least a first intense peak with a 2 theta (θ) value in a range of 17 to 20°, preferably about 19°; at least a second intense peak with a 2θ value in a range of 28 to 34°, preferably about 31°; at least a third intense peak with a 2θ value in a range of 34 to 40°, preferably about 37°; at least a fourth intense peak with a 2θ value in a range of 40 to 47°, preferably about 43 to 44°; and at least a fifth intense peak with a 2θ value in a range of 55 to 75° preferably about 60 to 63°, as depicted in FIG. 2.

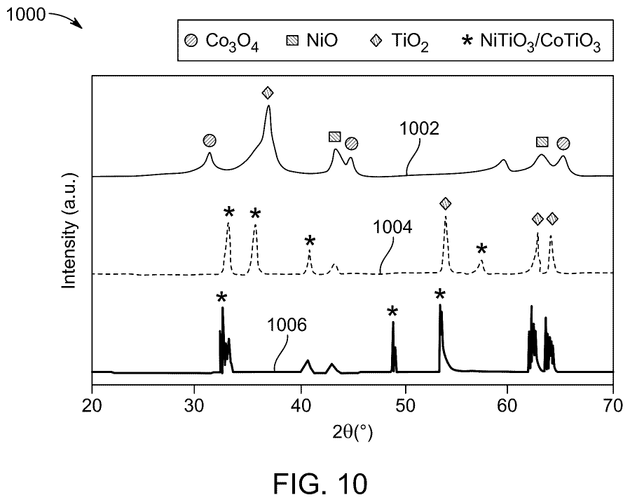

Referring to FIG. 10, XRD profiles for the 25NCT catalyst calcined at different calcination temperatures. In some embodiments, the NCT catalyst calcined at about 500° C. has at least a first intense peak with a 2θ value at 25 to 32°, preferably about 30°; at least a second intense peak with a 2θ value of 33 to 38°, preferably about 35°; at least a third intense peak with a 2θ value of 41 to 45°, preferably about 43°; at least a fourth intense peak with a 2θ value of 56 to 60°, preferably about 58°; and at least a fifth intense peak with a 2θ value of 61 to 66°, preferably about 63°, as depicted in FIG. 10. In some embodiments, the NCT catalyst calcined at about 700° C. has at least a first intense peak with a 2θ value at 32 to 33°, preferably about 32.5°; at least a second intense peak with a 2θ value of 33 to 36°, preferably about 34°; at least a third intense peak with a 20 value of 40 to 45°, preferably about 41 to 43°; at least a fourth intense peak with a 2θ value of 52 to 60°, preferably about 53 to 58°; and at least a fifth intense peak with a 2θ value of 61 to 66°, preferably about 63°, as depicted in FIG. 10. In some embodiments, the NCT catalyst calcined at about 900° C. has at least a first intense peak with a 2θ value at 32 to 35°, preferably about 34°; at least a second intense peak with a 2θ value of 38 to 41°, preferably about 40°; at least a third intense peak with a 2θ value of 41 to 45°, preferably about 41 to 43°; at least a fourth intense peak with a 2θ value of 46 to 50°, preferably about 48°; at least a fifth intense peak with a 2θ value of 53 to 58°, preferably about 55°; and at least a sixth intense peak with a 2θ value of 61 to 66°, preferably about 63°, as depicted in FIG. 10. Other ranges are also possible.

Referring to FIG. 1B, a method 100 for producing H₂ from CH₄ is described. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes introducing a feed gas stream containing CH₄ into a reactor containing a nickel (Ni) and cobalt (Co)-based titania supported (NCT) catalyst, including the NCT catalyst particles. Apart from CH₄, the feed gas stream includes one or more selected from ethane, propane, butane, nitrogen, and argon, with methane being the predominant component in the feed gas stream. In an example, the CH₄ is present in the feed gas stream at a concentration of 50 to 99 vol. %, preferably 60 to 98 vol. %, preferably 70 to 97 vol. %, preferably 80 to 96 vol. %, or even more preferably 90 to 95 vol. %, based on the total volume of the feed gas stream. Other ranges are also possible.

The gas stream is fed into the reactor, which is at least one selected from the group consisting of a fixed-bed reactor, a trickle-bed reactor, a moving bed reactor, a rotating bed reactor, a fluidized bed reactor, and a slurry reactor. For the purposes of this disclosure, the reactor is a fixed-bed reactor in the form of a cylindrical reactor. The reactor includes a top portion, a cylindrical body portion, a bottom portion, and a housing having an open top and open bottom supportably maintained with the cylindrical body portion. The NCT catalyst particles are supportably retained within the housing, permitting fluid flow therethrough. Further, at least one propeller agitator is disposed in the bottom portion of the reactor. The bottom portion is cone-shaped or pyramidal. A plurality of recirculation tubes fluidly connects the bottom portion of the cylindrical reactor with the cylindrical body portion of the cylindrical reactor.

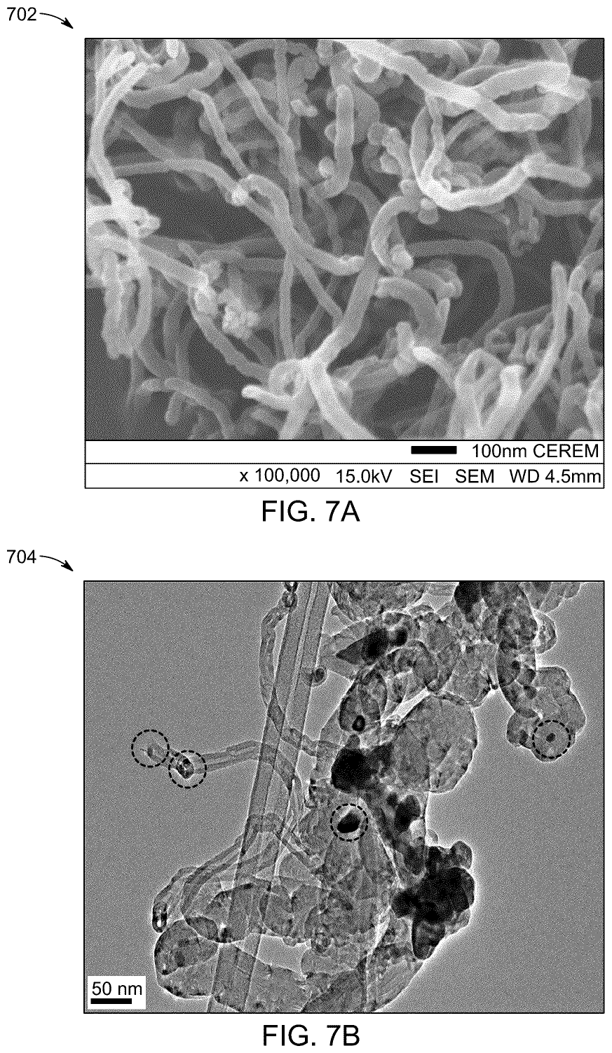

At step 104, the method 100 includes passing the feed gas stream through the reactor in contact with the NCT catalyst particles at a temperature of 600 to 1000° C., preferably 700 to 900° C., or even more preferably about 800° C. to convert at least a portion of the CH₄ to carbon (C) and H₂ and produce a H₂-containing gas stream leaving the reactor. In this step, the feed gas stream is in contact with the NCT catalyst particles at a temperature of 700 to 800° C., or even more preferably about 750° C. under atmospheric pressure. In some embodiments, the passing of the feed gas stream is performed at a gas hourly space velocity (GHSV) of 2 to 10 liters of the feed gas stream of every gram of the NCT catalyst per hour (L/(h·g_{cat})), preferably 3 to 9 L/(h·g_{cat}), preferably 4 to 8 L/(h·g_{cat}), or even more preferably 5 to 7 L/(h·g_{cat}). Other ranges are also possible. The carbon formed during the conversion is deposited on the surfaces of the NCT catalyst particles, as depicted in FIGS. 7A and 7B. The carbon deposited on the surface of the NCT catalyst is in the form of multi-walled carbon nanotubes (MWCNTs). The MWCNTs are hollow multi-walled carbon nanotubes having open tips. The Ni and Co particles reside within the inner surfaces of the hollow multi-walled carbon nanotubes. The MWCNTs have an average diameter of 10 to 60 nanometers (nm), preferably 20 to 50 nm, or even more preferably 30 to 40 nm. In some further embodiments, the MWCNTs have a length in a range of 100 nm to 9 millimeters (mm), preferably 1000 nm to 8 mm, preferably 10 micrometers (μm) to 7 mm, preferably 100 μm to 6 mm, preferably 1000 μm to 5 mm, preferably 2 to 4 mm, or even more preferably about 3 mm. Other ranges are also possible. The H₂-containing gas stream leaving the reactor is substantially free from carbon oxides (COₓ).

As used herein, the term “substantially free,” or “free” unless otherwise specified, describes a particular component being present in an amount of less than about 1 wt %, preferably less than about 0.5 wt %, more preferably less than about 0.1 wt %, even more preferably less than about 0.05 wt %, even more preferably less than about 0.01 wt %, even more preferably less than about 0.001 wt %, yet even more preferably 0 wt %, relative to a total weight of the composition being discussed.

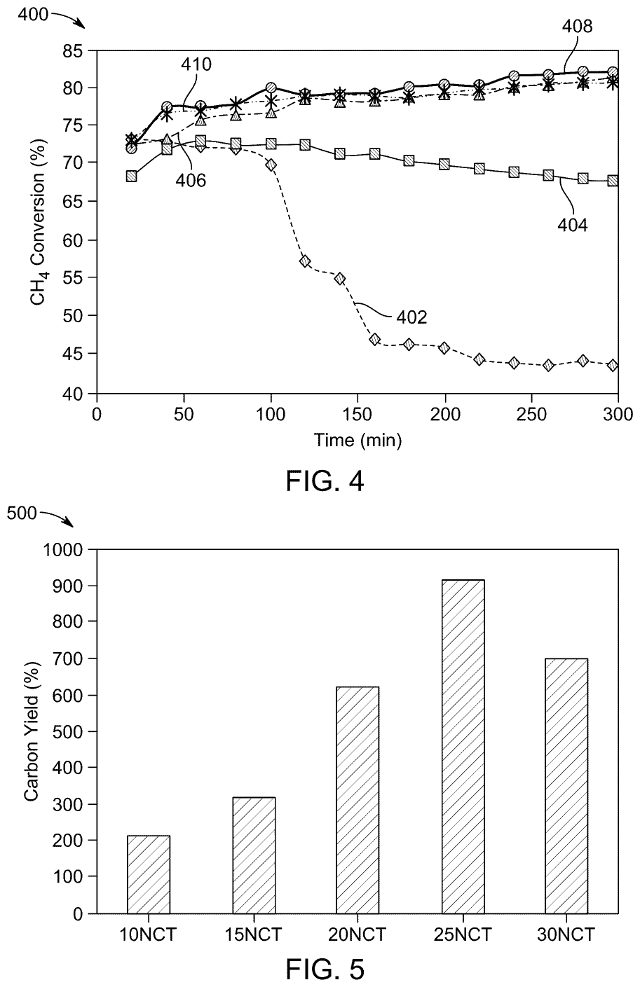

At step 106, the method 100 includes separating the H₂ from the H₂-containing gas stream. The H₂-containing gas stream may also contain trace amounts of sulfur which is removed during the separation process. More than 70%, preferably 75%, preferably 80%, preferably 85%, preferably 90%, and preferably 95% of the CH₄ is converted based on the initial weight of the CH₄ in the feed gas stream, at a temperature of about 600 to 800° C., or even more preferably about 700° C., as depicted in FIG. 4. Also, the H₂ yield is up to 95%, preferably up to 93%, or even more preferably up to 90%, based on the CH₄ conversion.

### EXAMPLES

The following examples describe and demonstrate exemplary embodiments as described herein. The examples are provided solely for the purpose of illustration and are not to be construed as limitations of the present disclosure, as many variations thereof are possible without departing from the spirit and scope of the present disclosure.

### Example 1: Catalyst Preparation

All the precursors, including nickel nitrate [Ni(NO₃)₂·6H₂O; 99% purity], cobalt nitrate [Co(NO₃)₂·6H₂O; 99% purity] obtained from Sigma-Aldrich®, and titanium iso-propoxide [Ti{OCH(CH₃)₂}₄] obtained from Alfa Aesar, were used without further purification. The catalysts based on Ni and Co supported over titania were prepared using the co-precipitation technique. First, stoichiometric amounts of the precursors were first dissolved in 20 mL of ethanol. Then, water was added to the solution due to the strong hygroscopic nature of titanium isopropoxide. Next, 10% ammonia (NH₃) solution was added as the precipitating agent until pH reached 9.

The solution was heated to 60° C. and kept at the temperature for 3 hours under constant stirring. Afterward, the heating was stopped, and the solution was allowed to settle overnight to let the precipitates settle down. The precipitates were then filtered, washed several times with distilled water and acetone several times to remove impurities, and dried overnight at 120° C. Subsequently, the catalysts were calcined at 500° C., 700° C., and 900° C. for 3 hours. Finally, the catalyst was crushed into powder to use for the reaction. The prepared catalysts were named as xNCT where N, C, and T represent Ni, Co, and titania, respectively, while x varies from 10 to 30 wt. %.

### Example 2: Catalyst Characterization

X-ray diffraction (XRD) analysis of the catalyst samples was conducted using a Rigaku diffractometer with Cu Kα radiation source operating at 40 kV and 15 mA. The analysis was carried out with a step size of 0.02 and a scanning range of 10-90 for analysis. Phase analysis was performed using the X'Pert HighScore Plus software matched with Joint Committee on Powder Diffraction Standards (JCPDS) database. Nitrogen (N₂) physisorption isotherms study of the catalyst sample was performed using a Micromeritics Tristar II 3020 instrument. The surface area was estimated using the Brunauer-Emmet Teller (BET) method, while the pore volume and pore diameter were estimated using the Barrett-Joyner-Halenda (BJH) method. The reducibility of the catalyst sample was studied by H₂-temperature-programmed reduction (TPR) over Micromeritics Auto Chem II 2920, USA. A sample of 70 mg was subjected to heat treatment at a rate of 10° C./min up to 900° C. under a gas flow of 30 mL/min of a 10% H₂/Argon (Ar) mixture gas.

### Example 3: Catalyst Activity Test

The catalytic decomposition of methane was performed over 0.15 g of catalyst packed in a fixed-bed stainless steel tubular micro-reactor at atmospheric pressure. The stainless steel tubular micro-reactor had a length (L) of 30 cm and an interior diameter (I.D) of 9.1 mm. The temperature within the reactor was monitored by a K-type stainless steel sheathed thermocouple positioned axially at the centre of the catalyst bed. Before the reaction, the catalyst was activated under 40 mL/min flow of H₂ for 60 min at 600° C., followed by purging of N₂ for 15 min to remove any remaining H₂. The temperature of the reactor was then raised to 800° C. under a flow of N₂. A mixture of 15 mL/min of CH₄ and 5 mL/min of N₂ (total flow rate of 20 mL/min) was allowed to pass through the catalyst bed at 800° C. with an equivalent space velocity of 8000 mL/h/g_{cat}. GC-2014 SHIMADZU (Column: Molecular Sieve 5A and Porapak Q; carrier gas: Argon) equipped with a conductivity detector was used to analyze the feed and output gas composition. The expression for CH₄ conversion and H₂ and carbon yield are mathematically represented using Equations (1) and (2), respectively.

$${CH}_{4} conversion = \frac{{CH}_{4 , in} - {CH}_{4 , out}}{{CH}_{4 , in}} \times 100 \% \qquad ( 1 )$$

$$Carbon yield = \frac{weight of carbon formed}{weight of total metal contents} \times 100 \% \qquad ( 2 )$$

### Example 4: Characterization of Fresh Catalysts

The textural properties, including specific surface area, pore volume, and pore diameter of the xNCT catalysts are described in Table 1 provided below. It is evident that an increase in the total metal content from 20 to 50 wt. % results in an increase in specific surface area. However, further increasing the total metal loading to 60 wt. % leads to a reduction in the specific surface area. For example, 10NCT has a specific surface area of 48.1 m²/g, while 25NCT reaches a higher value of 115.1 m²/g, and 30NCT shows a decrease in surface area (104.2 m²/g). The increase in specific surface area with respect to metal loading can be attributed to the existing number of metal particles over the surface of the catalyst. Furthermore, the surface-to-pore penetration (SPP) is a function of metal loading and remains relatively small up to a total metal loading of 50 wt. %. However, further increment of loading promotes SPP, resulting in decreased specific surface area. The specific surface area plays a significant role in catalytic activity, and therefore, the higher specific surface area of 25NCT is expected to outperform the rest of the catalysts.

TABLE 1
Textural Properties for xNCT catalysts

| | Pre-reaction | | | Post-reaction | | | Hydro- | |
|---|---|---|---|---|---|---|---|---|
| | | | Pore | | | Pore | gen | |
| | | Pore | Dia- | | Pore | Dia- | uptake | |
| | S_{BET} | Volume | meter | S_{BET} | Volume | meter | (mmol/ | DR |
| Catalyst | (m²/g) | (cm³/g) | (nm) | (m²/g) | (cm³/g) | (nm) | g)^{a} | (%)^{b} |
| 10NCT | 48.1 | 0.14 | 11.2 | 26.9 | 0.09 | 14.4 | 2.89 | 97.2 |
| 15NCT | 50.9 | 0.17 | 13.5 | 32.5 | 0.12 | 15.5 | 4.13 | 92.5 |
| 20NCT | 88.9 | 0.27 | 11.3 | 29.7 | 0.11 | 15.4 | 5.39 | 90.5 |
| 25NCT | 115.1 | 0.35 | 11.1 | 31.4 | 0.11 | 15.4 | 6.49 | 87.3 |
| 30NCT | 104.2 | 0.36 | 12.6 | 26.3 | 0.09 | 15.0 | 8.19 | 91.8 |

^{a}From H₂-TPR
^{b}Degree of reduction (DR %) = 100 × (H₂ consumed during H₂-TPR/Theoretical H₂ required for complete reduction)

FIG. 2 shows a plot 200 illustrating XRD profiles for two catalysts of xNCT catalysts series including 20NCT and 25NCT catalysts, according to certain embodiments. In the plot 200, plot line 202 represents the XRD profile of 20NCT catalyst, and plot line 204 represents XRD profile of the 25NCT catalyst. It can be observed that the two diffractograms nearly overlap. and the difference between them lies in the peak intensity, which increases with an increase in metal loading. The diffractograms exhibit peaks at 19°, 31.3°, 44.8° and 65.2°, which may be attributed to Co₃O₄ [JCPDS: 00-042-1467], while peaks at 43.3° and 63° can be associated with NiO [JCPDS: 00-044-1159]. The only peak at 37° may be attributed to the presence of the anatase phase of TiO₂ [JCPDS: 00-65-5714]. It can be seen that the catalysts did not exhibit the formation of any titanate species, such as NiTiO₃ and/or CoTiO₃.

FIG. 3 shows a plot 300 illustrating TPR profiles for three catalysts of xNCT series including 20NCT, 25NCT, and 30NCT catalysts, according to certain embodiments. In the plot 300, plot line 302 represents the TPR profile of the 20NCT catalyst, plot line 304 represents the TPR profile of the 25NCT catalyst, and plot line 306 represents the TRP profile of the 30NCT catalyst.

The activation and/or reduction of the catalyst prior to the reaction is a crucial step to convert metal oxides into their active metal form. In this context, temperature-programmed reduction using hydrogen (H₂-TPR) as a probe gas is a useful tool for investigating the reduction temperature and identifying the extent of interaction between the metal and support. H₂-TPR profiles for xNCT catalysts exhibit three distinct peaks, except for the 20NCT catalyst, which shows four peaks in FIG. 3. In the first peak lies within 150 to 300° C., with peak maxima at 236° C. The second peak shows a maxima at 353° C., while the third and fourth peaks are found within the temperature range of 420-600° C. (maxima at 531° C.) and at a temperature higher than 600° C. (peak maxima at 692° C.), respectively. The first peak can be attributed to the reduction of NiO and Co₃O₄, which have a very weak interaction with the support. The second and the third peaks may be assigned to the two-step reduction of Co₃O₄ to Co⁰ (Co₃O₄→CoO→Co⁰°). The fourth peak may be attributed to the strong interaction of metal oxides (NiO and Co₂O₃) with the support. This high-temperature reduction peak has been reported previously for titania-supported catalysts and is associated with the partial reduction of Titania. In order to investigate this observation further, the degree of reduction (DR) for all the catalysts as shown in Table 1 was calculated.

It is evident that all the catalysts demonstrate DR values below 100%, indicating that no hydrogen spillover is observed, which is commonly associated with the reduction of the support material. Additionally, the peak above 600° C. disappears in the case of 25NCT and 30NCT catalysts, indicating relatively weaker metal-support interaction (MSI) due to the presence of more particles on the catalysts' surface. Furthermore, the peak maxima temperatures shift towards lower temperatures as the metal content is increased, indicating an increase in reducibility. This increased reducibility may potentially contribute to the catalytic methane cracking (CMC) reaction.

Referring to FIG. 4, a plot 400 illustrating catalytic performance curves in terms of CH₄ conversion for xNCT catalysts at temperature of 700° C. are described. In the plot 400, plot line 402 represents the catalytic performance curve of the 10NCT catalyst, plot line 404 represents the catalytic performance curve of the 15NCT catalyst, plot line 406 represents the catalytic performance curve of the 20NCT catalyst, plot line 408 represents the catalytic performance curve of the 25NCT catalyst, and plot line 410 represents the catalytic performance curve of the 30NCT catalyst.

### Example 5: Activity Performance Tests

The activity patterns depicted in FIG. 4 indicate that the total metal content, varying between 20 and 60 wt. %, significantly impacts CH₄ conversion. The 10NCT catalyst containing 10 wt. % each of Ni and Co exhibits an initial CH₄ conversion of approximately 73%, which gradually decreases over the course of the CMC reaction, levelling off at around 44% after 300 minutes. With a further increase in total metal content to 30 wt. %, the 15NCT catalyst shows slightly lower initial CH₄ conversion (approximately 68%). The 15NCT catalyst demonstrates an induction period where CH₄ conversion reaches around 73% and remains stable for the next 60 minutes before declining to a final conversion of 67% (at the end of 300 minutes). The initial activity trend for higher metal contents, i.e., 20NCT, 25NCT, and 30NCT catalysts, remains consistent with CH₄ conversion ranging from 71-73%. Similar to the 15NCT catalyst, these catalysts also exhibit an induction period, and CH₄ conversion continues to increase until reaching final conversions of 80.5%, 81.5%, and 82.5% for 20NCT, 30NCT, and 25NCT catalysts, respectively. Among these catalysts, the 25NCT catalyst with the highest CH₄ conversion of 82.5% is found to be the optimum catalyst. Based on the catalytic performance, the xNCT catalysts can be categorized in descending order as 25NCT>30NCT>20NCT>15NCT>10NCT.

In general, the carbon yield during CMC is calculated by dividing the amount of carbon produced by the total metal content in the catalyst. Referring to FIG. 5, a plot 500 illustrating carbon yield data for xNCT catalysts is described. The carbon yield varies with an increase in the total metal content from 20 wt. % to 60 wt. %. For example, 10NCT catalyst exhibits a carbon yield of 215%, which increases to 630% when the metal content is doubled (20NCT). A further increase in metal content (25NCT) yields as high as 915% of carbon, which eventually reaches 700% at a total metal loading of 60 wt. %. The carbon yield data follows the same descending order as the CH₄ conversion, i.e., 25NCT>30NCT>20NCT>15NCT>10NCT. In conclusion, 25NCT catalyst remains an optimum total metal loading with respect to both CH₄ conversion and carbon yield. Similar for the total metal loading have been reported in the literature for various supports other than titania.

The catalytic performance of 25NCT catalyst can be attributed to several factors. Firstly, the higher specific surface area of 25NCT catalyst promotes better dispersion of the metal particles and provides more active sites, facilitating the easier reduction of dispersed metal particles. Additionally, the suitable MSI in 25NCT catalyst reduces the susceptibility of metal particles to agglomeration, mainly due to a synergistic or alloy effect. In the CMC reaction mechanism, CH₄ activation occurs as the initial step over the active metal surface. After adsorption over the active metal surface, CH₄ dissociates, leading to the desorption of H₂ along with the formation of carbon. The formed carbon diffuses through the metal bulk and starts growing at the rare end. This carbon growth at the rare metal end forms graphene sheets, which further produce carbon nanomaterials. The reaction mechanism can also be explored using the information deduced from the structure and morphological analysis of formed carbon. Active metal particles play an essential role in the carbon growth mechanism, providing the necessary sites for carbon growth, particularly on the stepped surfaces of active metal particles. Metal particles' agglomeration and MSI also influence the reaction mechanism. It is evident that various parameters are responsible for the carbon growth mechanism during the CMC reaction. The absence of deactivation in higher loading catalysts (20NCT, 25NCT, and 30NCT) suggests that metal encapsulation is less significant in these catalysts, and they would have likely followed tip-growth, base-growth or a combination of both types of growth mechanisms.

Table 2 illustrates a comparison of xNCT catalysts with various bimetallic catalyst systems reported in the literature.

| | | | Activity | | |
|---|---|---|---|---|---|
| | Operating conditions | | Max. | Max. | |
| | Reaction | GHSV | Methane | Hydrogen | |
| | Temperature | (L/h. | conversion | Yield | |
| Catalyst | (° C.) | g_{cat}.) | (%) | (%) | Reference |
| 25Ni—25Co/SBA-15 | 700 | 5 | 38 | 56 | [Literature |
| 25Fe—25Co/SBA-15 | | | 35 | 50 | A] |
| 25Ni—25Fe/SBA-15 | | | 34 | 51 | |
| 25Ni—25Co/MgO | 700 | 6 | — | 78 | [Literature |
| 25Fe—25Co/MgO | | | — | 86* | B] |
| 25Ni—25Fe/MgO | | | — | ~69 | |
| 50Ni—10Cu—SiO₂ | 750 | 1.8 | 83 | — | [Literature |
| | | | | | C] |
| Fe50Cu50 (ITT) | 600 | 13.2 | 51 | — | [Literature |
| | | | | | D] |
| 0.5% Pd4.5% Fe/Al₂O₃ | 700 | 0.6 | — | 80* | [Literature |
| | | | | | E] |
| 15NCT | 700 | 5 | 68 | 72 | Present |
| 20NCT | | | 80.5 | 81* | Disclosure |
| 25NCT | | | 82.5 | 82* | |
| 30NCT | | | 81 | 81* | |

*Catalysts demonstrated no deactivation over time

Literature A—Pudukudy M, Yaakob Z, Akmal Z S. Direct decomposition of methane over SBA-15 supported Ni, Co and Fe based bimetallic catalysts. Appl Surf Sci 2015; 330:418-30.
Literature B—Awadallah A E, Aboul-Enein A A, El-Desouki D S, Aboul-Gheit A K. Catalytic thermal decomposition of methane to COx-free hydrogen and carbon nanotubes over MgO supported bimetallic group VIII catalysts. Appl Surf Sci 2014; 296:100-7.
Literature C—Saraswat S K, Pant K K. Synthesis of hydrogen and carbon nanotubes over copper promoted Ni/SiO₂ catalyst by thermocatalytic decomposition of methane. J Nat Gas Sci Eng 2013; 13:52-9.
Literature D—Cunha A F, Órfão J J M, Figueiredo J L. Methane decomposition on Fe—Cu Raney-type catalysts. Fuel Process Technol 2009; 90:1234-40.
Literature E—Shah N, Panjala D, Huffman G P. Hydrogen Production by Catalytic Decomposition of Methane. Energy & Fuels 2001; 15:1528-34.

The catalysts of present disclosure have been compared with various bimetallic catalyst systems reported in the literature, and the results demonstrate superior and/or competent activity performance under similar operating conditions. Previous studies have investigated different bimetallic catalyst systems for CMC, and this work is compared with those studies. For instance, in Literature A, researchers have evaluated Ni, Fe, and Co-based bimetallic catalysts supported on SBA-15. They found that the impregnated catalysts exhibited good dispersion of metal particles, and all the bimetallic catalysts had an equal weight percentage of 25 wt. % for each metal with a ratio of unity. The activity results indicated that all bimetallic catalysts i.e., 25Ni-25Co/SBA-15, 25Ni-25Fe/SBA-15, and 25Fe-25Co/SBA-15, remained active and stable for as long as 5 hour time-on-stream. Among the tested catalysts, the 25Ni-25Co/SBA-15 catalyst showed the highest activity with a hydrogen yield of 56%. However, despite its slightly lower hydrogen yield of 51%, the 25Fe-25Co/SBA-15 catalyst exhibited stable performance during a 5-hour reaction. The morphological and thermal stability analysis of spent catalysts indicated the formation of open-tip hollow multi-walled carbon nanotubes with higher oxidation stability and graphitization degree. A similar bimetallic catalyst system based on Ni, Fe, and Co supported on MgO is also reported elsewhere. Their findings regarding activity and stability are in contrast to what has been reported in Literature B. The catalyst with 25 wt. % each of Fe and Co (25Fe-25Co/MgO) remained stable for approximately 10 hours with a hydrogen yield of approximately 86%. However, 25Ni-25Co/MgO and 25Ni-25Fe/MgO displayed poor catalytic performance, which was attributed to the formation of a solid solution between NiO and MgO, i.e., MgₓNi₍₁₋ₓ₎O. This solid solution formation inhibits the reduction of NiO, leading to lower activity of Ni-based catalysts during the reaction. On the contrary, the existence of fairly-distributed non-interacting oxides of Fe and Co in the 25Fe-25Co/MgO catalyst facilitated their higher activity performance. In comparison with these catalyst systems, Ni—Co bimetallic catalysts of the present disclosure, supported on TiO₂ with the same amount of metal loading, have demonstrated higher catalytic activity.

### Example 6: Characterization of Spent Catalysts

The evaluation of the textural properties of xNCT catalysts after a 5 hour CMC reaction depicts that the specific surface area for all catalysts decreases compared to the fresh catalysts. This decrease in surface area can be attributed to both metal sintering and carbon deposition. Since carbon is a byproduct of this reaction, it becomes the main reason contributing to the decrease in catalyst surface area after 300 minutes of reaction. The extent of surface area loss varies among the catalysts, with the 25NCT catalyst showing the highest loss of specific surface area (a difference of 83.7 m²/g) compared to the rest of the catalysts. This indicates that metal particle agglomeration and carbon deposition have strongly affected the textural properties of the 25NCT catalyst. The spent catalysts are subjected to thermo-gravimetric analysis (TGA) to identify the extent of weight loss with respect to temperature. Moreover, TGA evaluates the nature of carbonaceous species under oxidative environment.

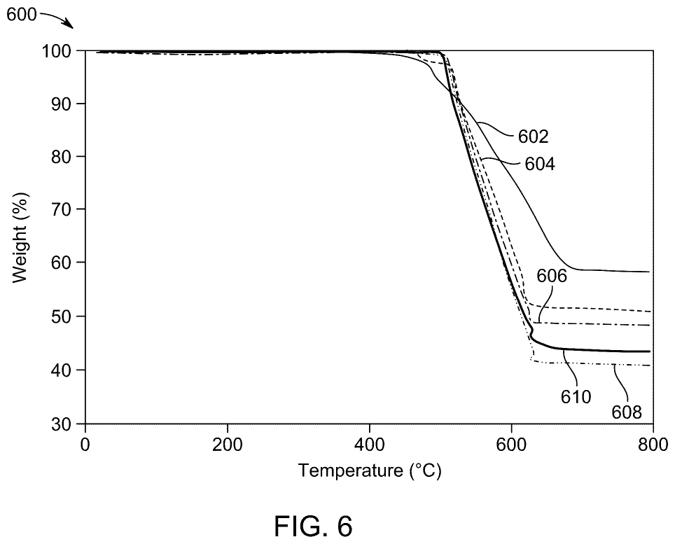

Referring to FIG. 6, a plot 600 illustrating TGA curves for xNCT spent catalysts is described. In plot 600, plot line 602 represents the TGA curve for the 10NCT catalyst, plot line 604 represents the TGA curve for the 15NCT catalyst, plot line 606 represents the TGA curve for the 20NCT catalyst, plot line 608 represents the TGA curve for the 25NCT catalyst, and plot line 610 represents the TGA curve for the 30NCT catalyst. The TGA curves from FIG. 6 show that a shoulder prior to a sharp weight loss, which indicates the formation of MWCNTs, in agreement with high resolution transition electron microscope (HRTEM) micrographs. In all the post-reaction xNCT catalysts, the weight loss begins at a temperature of approximately 400° C. and is completed at around 700° C., signifying the deposition of highly stable thick MWCNTs.

The morphological analysis to identify the type of carbon deposited over the 25NCT catalyst surface during the CMC reaction was carried out using scanning electron microscope (SEM) and HRTEM. Referring to FIG. 7A, SEM micrograph 702 of the 25NCT spent catalyst is described and referring to FIG. 7B, HRTEM micrograph 704 of the 25NCT spent catalyst is described.

The SEM micrograph 702 displayed in FIG. 7A clearly shows the formation of filamentous carbon. The intermingling of carbon nanotubes (CNTs) makes it challenging to approximate the exact fiber lengths. However, some of the fibers were evaluated to be a few millimeters long. The HRTEM micrograph 704 displayed in FIG. 7B for the spent 25NCT catalyst has revealed entangled low-density CNTs containing active metal particles. Various forms of CNTs are grown, such as chain-like CNTs, CNTs with metal nanoparticles on tip-sites, closed-ends CNTs with and without metal on tip-sites, and CNTs with varying diameters from one section to neighboring sections. Similar findings are already reported for Ni—Co-based and Ni—Cu—Zn-based catalysts. Furthermore, HRTEM established that the CNTs deposited during CMC are multi-walled with diameters within 12 to 60 nm.

The morphological analysis using HRTEM provides insight into the growth mechanism of carbon deposition. The location of active metal particles facilitates the identification of growth mechanism, i.e., either tip-growth (TG) or base-growth (BG) types. FIG. 7B clearly shows the presence of active metal particles not only on the tip but also within the CNTs indicating that carbon formation follows both TG and BG mechanisms. The carbon growth by both the mechanisms infers that some of the active metal particles, detached from the support, have served as active sites for methane conversion, promoting the TG mechanism, while some of the metal particles residing under the CNTs facilitate the BG mechanism. It has been suggested that MSI plays a role in influencing the carbon growth mechanism, and a stronger MSI promotes BG mechanism and vice versa. Similar findings have also been reported in earlier investigations for Ni—Co and Fe—Mo based bimetallic catalysts.

### Example 7: Calcination Temperature Test

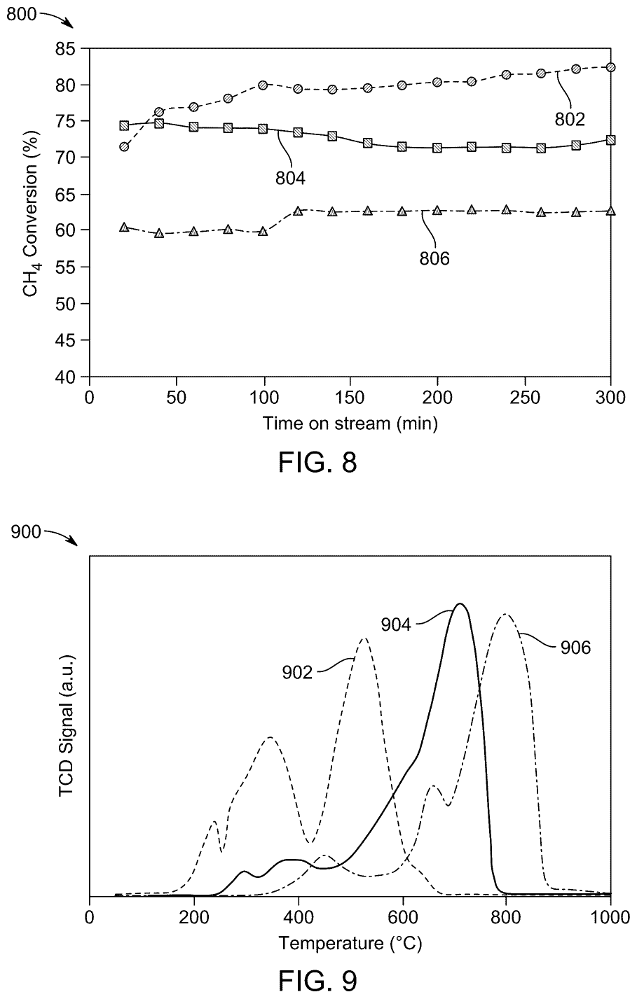

The pre-treatment step during catalyst synthesis plays a crucial role in influencing the catalytic performance during the CMC reaction. The heat treatment or calcination during catalyst preparation helps not only to obtain metal oxide but also to stabilize phase. The calcination temperature needs to be optimized, as choosing a temperature above the optimum level can affect the textural properties and cause metal agglomeration or sintering. Since the 25NCT catalyst was found to be an optimum-loaded catalyst with the highest activity, the variation of calcination temperature, i.e., 500° C., 700° C., and 900° C. was investigated for this catalyst. Referring to FIG. 8, a plot 800 illustrating catalytic activity profiles for 25NCT catalyst at different calcination temperatures is described. In plot 800, plot line 802 shows the catalytic activity profile for the 25NCT catalyst at a calcination temperature of 500° C., plot line 804 shows the catalytic activity profile for the 25NCT catalyst at a calcination temperature of 700° C., and plot line 806 shows the catalytic activity profile for the 25NCT catalyst at a calcination temperature of 900° C. Table 3 describes the textural properties at various calcination temperatures for the 25NCT catalyst.

TABLE 3
Textural properties for the 25NCT catalyst at
different calcination temperatures

| | | | | | | | Activity |
|---|---|---|---|---|---|---|---|
| Calcin- | Pre-reaction | | | Post-reaction | | | Max. |
| ation | | | Pore | | | Pore | Hydro- |
| Temp- | | Pore | dia- | | Pore | dia- | gen |
| erature | S_{BET} | volume | meter | S_{BET} | volume | meter | Yield |
| (° C.) | (m²/g) | (cm³/g) | (nm) | (m²/g) | (cm³/g) | (nm) | (%) |
| 500 | 115.1 | 0.35 | 11.1 | 31.4 | 0.11 | 15.4 | 82 |
| 700 | 13.4 | 0.12 | 37.3 | 27.3 | 0.11 | 17.4 | 75 |
| 900 | 2.3 | 0.02 | 25.8 | 17.6 | 0.06 | 14.2 | 69 |

The CH₄ conversion results described in FIG. 8 and the maximum hydrogen yield in Table 3 demonstrate that the variation in calcination temperature has a significant impact on the catalytic activity. It is evident from the catalytic performance curves that higher calcination temperatures of 700° C. and 900° C. have a deteriorating effect on CH₄ conversion. At lower calcination temperature (500° C.), the initial CH₄ conversion remains at 71.5%, while higher calcination temperature of 700° C. and 900° C. exhibit initial conversions of 74.5% and 60.5%, respectively. However, despite higher initial conversion at 700° C., the conversion starts to decline with time and levels off at approximately 72.5%, in contrast to the final conversion of 82.5% for calcination temperature of 500° C. A similar trend was also observed for hydrogen yield, where a maximum yield of 82%, 75%, and 69% is observed at calcination temperatures of 500° C., 700° C., and 900° C., respectively. These findings are consistent with earlier reported results for monometallic nickel-based catalysts and bimetallic nickel and cobalt-based catalysts.

Referring to FIG. 9, a plot 900 illustrating TPR profiles for the 25NCT catalyst at different calcination temperatures is described. In FIG. 9, plot line 902 represents the TPR profile of the 25NCT catalyst at a calcination temperature of 500° C., plot line 904 represents the TPR profile of the 25NCT catalyst at a calcination temperature of 700° C., and plot line 906 represents the TRP profile of the 25NCT catalyst at a calcination temperature of 900° C. For the 25NCT catalyst, three reduction peaks can be seen at a calcination temperature of 500° C. The first peak is centered at 237° C., the second at 350° C., and the third at 528° C. As the calcination temperature is increased from 500° C. to 700° C., it is evident that the H₂ consumption at low temperature is significantly reduced, showing a lesser area under the curve for both low-temperature peaks, while high-temperature peak shifts well towards temperatures over 700° C., indicating the existence of species that are difficult to reduce.

Similarly, as the calcination temperature is increased to 900° C., reduction peaks shift to as high as 800° C. temperature, indicating that the metal interacts strongly with the bulk of the support and forms such species that are difficult to reduce completely. These factors are responsible for the deteriorating catalytic performance at higher calcination temperatures.

Referring to FIG. 10, a plot 1000 illustrating the XRD profiles for the 25NCT catalyst at different calcination temperatures is described. In plot 1000, plot line 1002 represents the XRD pattern of the 25NCT catalyst at a calcination temperature of 500° C., plot line 1004 represents the XRD pattern of the 25NCT catalyst at a calcination temperature of 700° C., and plot line 1006 represents the XRD pattern of the 25NCT catalyst at a calcination temperature of 900° C.

It can be observed that the diffractograms at higher calcination temperatures of 700° C. and 900° C. contain both overlapping and distinct peaks, indicating how the calcination process affected the crystallinity of the catalyst. Comparing the 500° C. calcination with higher calcination temperatures, it is evident that the XRD profiles for higher calcination temperatures share only one peak with the lower calcination temperatures, which is located at 43.3° and associated with NiO. Interestingly, no Co₃O₄ peaks were observed at higher calcination temperatures, indicating the formation of titanate phases (NiTiO₃ and CoTiO₃). The peaks at 33.1° and 41° for both higher calcination temperatures were attributed to NiTiO₃ [JCPDS: 00-33-0960] and rutile phase of TiO₂ [JCPDS: 00-65-1119], respectively. For the 700° C. calcination, the peaks appearing at 540 and 64° may be assigned to rutile TiO₂, while the peak at 62.7° may be ascribed to anatase TiO₂ [JCPDS: 00-65-5714]. The diffraction patterns at 35.7° and 57.3° can be attributed to NiTiO₃ [JCPDS: 00-33-0960] and CoTiO₃ [JCPDS: 00-77-0153], respectively. Moreover, at 900° C. calcination temperature, the diffractograms appearing at 32.6°, 48.9°, 53.4°, and 63.5° were assigned to CoTiO₃ and peak at 62.1° was attributed to anatase TiO₂. It is notable that at higher calcinations, more formation of titanate phases was observed, which negatively influenced the catalytic performance of the catalyst.

The present disclosure focuses on nickel and cobalt-based bimetallic catalysts supported on Titania, referred to as xNCT catalysts, where x=10 to 30 wt. % for methane cracking to produce hydrogen and carbon nanotubes. The total metal loading varied between 20 and 60 wt. %, while the nickel to cobalt ratio was kept at unity. In comparison with low-loading catalysts, such as 10NCT catalyst and 15NCT catalyst, high-loading catalysts such as 20NCT catalyst, 25NCT catalyst, and 30NCT catalyst have shown higher activity and stability performances. Among the high-loading catalysts, the 25NCT catalyst outperformed the rest with the highest methane conversion and carbon yield. The higher specific surface area (115.1 m²/g), evaluated from physisorption, facilitates better metal particle dispersion, suitable metal-support interaction, and a higher number of reducible species determined by TPR, which have played a vital role in enhancing the activity of the 25NCT catalyst.

Numerous modifications and variations of the present disclosure are possible in light of the above teachings. It is therefore to be understood that within the scope of the appended claims, the invention may be practiced otherwise than as specifically described herein.

1: A method for producing hydrogen (H₂) from methane (CH₄), comprising:
introducing a feed gas stream containing CH₄ into a reactor containing a nickel (Ni) and cobalt (Co)-based titania supported (NCT) catalyst comprising NCT catalyst particles;
wherein the Ni is present in the NCT catalyst at a concentration of 20 to 30 wt. % based on a total weight of the NCT catalyst;
wherein the Co is present in the NCT catalyst at a concentration of 10 to 30 wt. % based on the total weight of the NCT catalyst;
passing the feed gas stream through the reactor in contact with the NCT catalyst particles at a temperature of 600 to 1000° C. to convert at least a portion of the CH₄ to carbon (C) and H₂, and produce a H₂-containing gas stream leaving the reactor;
wherein the C formed during the CH₄ conversion is deposited on surfaces of the NCT catalyst particles; and
separating the H₂ from the H₂-containing gas stream;
wherein the method has a CH₄ conversion of up to 95% based on an initial weight of the CH₄ in the feed gas stream; and
wherein the method has a H₂ yield of up to 90% based on the CH₄ conversion.

2: The method of claim 1, wherein the CH₄ is present in the feed gas stream at a concentration of 50 to 95 vol. % based on a total volume of the feed gas stream.

3: The method of claim 1, wherein the feed gas stream further comprises ethane, propane, butane, nitrogen, and argon.

4: The method of claim 1, wherein the reactor is at least one selected from the group consisting of a fixed-bed reactor, a trickle-bed reactor, a moving bed reactor, a rotating bed reactor, a fluidized bed reactor, and a slurry reactor.

5: The method of claim 1, wherein the reactor is a fixed-bed reactor in the form of a cylindrical reactor comprising:
a top portion;
a cylindrical body portion;
a bottom portion;
a housing having an open top and open bottom supportably maintained with the cylindrical body portion;
wherein the NCT catalyst particles are supportably retained within the housing permitting fluid flow therethrough;
at least one propeller agitator is disposed in the bottom portion of the reactor;
wherein the bottom portion is cone shaped or pyramidal; and
wherein a plurality of recirculation tubes fluidly connects the bottom portion of the cylindrical reactor with the cylindrical body portion of the cylindrical reactor.

6: The method of claim 1, wherein during the passing, the feed gas stream is in contact with the NCT catalyst particles at a temperature of 700 to 800° C. under atmospheric pressure.

7: The method of claim 1, wherein the passing is performed at a gas hourly space velocity (GHSV) of 2 to 10 liters of the feed gas stream of every gram of the NCT catalyst per hour (L/(h·g_{cat})).

8: The method of claim 1, wherein the carbon deposited on surfaces of the NCT catalyst is in the form of multi-walled carbon nanotubes (MWCNTs).

9: The method of claim 8, wherein the MWCNTs have an average diameter of 10 to 60 nanometers (nm) and a length in a range of 100 nm to 9 millimeters (mm).

10: The method of claim 8, wherein the MWCNTs are hollow multi-walled carbon nanotubes having open tips, and wherein Ni and Co particles reside within the inner surfaces of the hollow multi-walled carbon nanotubes.

11: The method of claim 1, wherein the H₂-containing gas stream leaving the reactor is free from carbon oxides (COₓ).

12: The method of claim 1, wherein the NCT catalyst particles have a specific surface area in a range of 30 to 140 square meter per gram (m²/g).

13: The method of claim 1, wherein the NCT catalyst particles have a cumulative specific pore volume in a range of 0.1 to 0.5 cubic centimeter per gram (cm³/g).

14: The method of claim 1, wherein the NCT catalyst particles have an average pore diameter in a range of 5 to 20 nm.

15: The method of claim 1, wherein the NCT catalyst particles have a hydrogen temperature-programmed reduction (H₂-TPR) of 1.5 to 10 millimoles per gram (mmol/g).

16: The method of claim 1, further comprising:
preparing the NCT catalyst by:
mixing a nickel salt and a cobalt salt in a first solvent to form a first mixture;
wherein a molar ratio of the nickel salt and the cobalt salt is in a range of 10:1 to 1:10;
adjusting a pH of the first mixture by adding an ammonia solution until the pH of the first mixture reaches about 9, and mixing with a titanium salt to form a reaction mixture;
heating the reaction mixture to form a catalyst precursor in the reaction mixture;
precipitating the catalyst precursor from the reaction mixture by cooling, filtering and drying to form the catalyst precursor in a solid form; and
calcining the catalyst precursor at a temperature of 500 to 900° C. to form the NCT catalyst;
wherein the Ni is present in the NCT catalyst at a concentration of 10 to 30 wt. % based on a total weight of the NCT catalyst; and
wherein the Co is present in the NCT catalyst at a concentration of 10 to 30 wt. % based on the total weight of the NCT catalyst.

17: The method of claim 16, wherein the cobalt salt comprises cobalt sulfate, cobalt acetate, cobalt citrate, cobalt iodide, cobalt chloride, cobalt perchlorate, cobalt nitrate, cobalt phosphate, cobalt triflate, cobalt bis(trifluoromethanesulfonyl)imide, cobalt tetrafluoroborate, cobalt bromide, and/or a hydrate thereof.

18: The method of claim 16, wherein the nickel salt comprises nickel sulfate, nickel acetate, nickel chloride, nickel nitrate, nickel carbonate, nickel phosphate and nickel oxalate, and/or a hydrate thereof.

19: The method of claim 16, wherein the titanium salt is at least one titanium alkoxide selected from the group consisting of titanium tetra-n-propoxide, titanium iso-propoxide, titanium tetramethoxide, titanium tetraethoxide, and titanium tetra-n-butoxide.

20: The method of claim 16, wherein the heating the reaction mixture is performed at a temperature of 40 to 100° C.
